(19) United States
(12) Patent Application Publication
(10) Pub. No.: US 2006/0251766 A1
(43) Pub. Date: Nov. 9, 2006

(54) Kit for providing sweeteners having non-standard sweetness levels

(76) Inventors: Steven Catani, Athens, GA (US); Ian Miller, Chicago, IL (US); Steven Clarke, North Brunswick, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/124,499

(22) Filed: May 6, 2005

(51) Int. Cl. A22C 17/10

(52) U.S. Cl. 426/87

(57) ABSTRACT

The invention relates to a kit containing a sweetener composition having a non-standard level of sweetness; and a container having a portion for holding the sweetener composition, said container having an indicator for communicating the sweetness intensity of the sweetener composition relative to the sweetness intensity of a standard unit dosage of sucrose. The kit is suitable for use in sweetening comestible products.

### CROSS-REFERENCE TO RELATED APPLICATIONS

This application is a continuation-in-part of the following applications, which were filed in the U.S. Patent Office on 26 Apr. 2005 and which are all incorporated by reference herein: “LOW CALORIE, PALATABLE SUGAR SUBSTITUTE WITH ENHANCED SWEETNESS” {Attorney Docket MSP 5026); “ENHANCING KIT FOR COMESTIBLE PRODUCTS,” {Attorney Docket MSP 5025); and “METHODS FOR PROMOTING COMESTIBLE PRODUCTS” {Attorney Docket MSP 5028).

### BACKGROUND OF THE INVENTION

1. Field of the Invention

This invention relates to kits containing sweeteners having non-standard sweetness levels, and methods for sweetening comestible products with such kits.

2. Description of the Prior Art

Consumers often add different types of flavors to the foods they consume in order to customize the taste to their personal preferences. One of the most commonly added flavor is sweetness. Sweeteners are typically added to beverages such as coffees and teas, on cereals, on fruits, as toppings on baked goods, and the like. The appeal of a product is typically increased as a result of sweetening. This preference is generally apparent in many cultures, but is particularly prevalent in western cultures.

One type of known sweetener is the “nutritive sweetener,” which not only provide sweetness but also are absorbable into the human bloodstream and are metabolized, thereby providing energy for immediate use or storage as fat. Examples of nutritive sweeteners include, but are not limited to sucrose, trehelose, tagatose, and the stereo-isomers of natural sugars, dextrose (glucose), and fructose. Consumers often flavor their foods with nutritive sweeteners in the form of sucrose (table sugar), crystalline dextrose (glucose), fructose, molasses, honey and other syrups such as corn syrup.

A well-known alternative to nutritive sweeteners are the high intensity sweeteners (“HIS”), which provide a means for sweetening products without the caloric burden and other metabolic impacts associated with nutritive sweeteners. Examples of nutritive sweeteners include, but are not limited to sucralose and aspartame.

Both nutritive and high intensity sweeteners are readily available in convenient unit dose packages containing free flowing powders, granules, crystals, agglomerate, particles, syrups, and solutions. Examples of such unit dose packaging include, but are not limited to packets, stick packets, sachets, and the like. Typically, such commercially available unit dose packaging contains a sweetener having the equivalent sweetness of 1 or 2 teaspoons of sugar; however, such packages may contain other useful quantities as disclosed in the aforementioned related patent applications.

Such unit dose packages of sweeteners are typically sold to consumers in multi-pack units. For example, containers with 50, 100, 200, 400, 400, and 2000 individual packets of SPLENDA® No Calorie Sweetener product are commercially available from McNEIL NUTRITIONALS, LLC. These unit dose packages are also available from multi-pack containers and dispensers in most restaurants, coffee shops, and the like. A single, unit dose package of sweetener is not only available at retail establishments, but is sometimes sent to consumers as single unit dose package samples.

In order to provide simplicity and avoid confusion for consumers as they switch between various sweetener alternatives, all consumer sweeteners are calibrated to the sweetness level provide by sucrose. For example, packets of sucrose contain 1 or 2 teaspoons of sucrose. Therefore, when a consumer uses a packet, they can easily calibrate the serving to the amount of sucrose typically spooned from a sugar bowl containing bulk sucrose. Not only are tablets and cubes formulated with HIS calibrated to sucrose equivalent teaspoons, but also liquid high intensity sweetener formulations are also designed so that a fixed number of drops provides the equivalence of a teaspoon of sucrose.

While the teaspoon is a well-established standard unit for sweetener quantity, and the sweetness of HIS has traditionally been calibrated to such standard units of sucrose as a standard, in actual practice a consumer customizes the amount of sweetener to his/her individual taste. Regardless of which sweetener, e.g. a nutritive sweetener, a non-nutritive sweeteners, or a high intensity sweetener, is selected, the user will encounter difficulties in customizing a sweetness level based upon a non-standard unit dose.

For example, consumers who desire to sweeten a product using sucrose cubes are limited in the amount of sweetness that can be achieved intermediate to the designed delivery amount in a cube, e.g. typically 1 teaspoon. The consumer has even less flexibility when using HIS formulated tablets, which are typically designed to provide 2 teaspoons. Although it is possible to break a cube or tablet in half or even smaller pieces, not only is this method messy, but the resulting pieces are often inconsistent in shape. Even if shape consistency could be obtained, the range of alternatives would still be limited to increments of a half teaspoon, i.e. 0.5 tsp, 1 tsp, 1.5 tsp, 2 tsp, 2.5 tsp. Another method to customize a sweetness level would include the crushing of a cube and use of only a part of the crushed material. While this approach would provide more flexibility, it is messy, wasteful, and hard to repeat on a consistent basis.

Bulk forms of sweeteners provide the consumer with the greatest flexibility in obtaining the desired sweetener level. The consumer can use a part of a spoonful, multiple spoonfuls, or combinations thereof to reach the desired sweet flavor level. While this approach is very flexible, bulk sweeteners are not typically available outside the home due to tampering concerns. Additionally, many consumers are still challenged by measuring less than teaspoon size quantities on a repeated basis. Many consumers also encounter difficulties in filling a teaspoon to the standard level on a repeated basis.

Packets or sachets containing a free flowing solid material not only provide a convenient way to deliver a unit quantity of sweetness, but they also facilitate a user's ability to customize sweetness levels to individual tastes. A consumer can use a full packet containing 1 or 2 teaspoon of sucrose equivalent sweetness, or use just part of a packet, or a combination thereof. As with bulk sweeteners, the use of sweetener packets provides for more flexibility in dosing because it is possible to use partial packets in order to get an infinite range of sweetness. However, in the event that the user desires to “customize a dose” by using, for example, a packet and a half of sweetener, it is often difficult to repeat such dose with certainty. Additionally, there is no simple way of storing an opened packet containing HIS for future use, so the unused sweetener in the second packet is often discarded.

It would be desirable to provide consumers with a bulk sweetening composition that has a non-standard sweetness per unit volume, along with a means for communicating how to tailor the composition to a user's individual sweetness level. It would further be desirable to provide such a sweetening composition in transportable, individual dose packages.

### SUMMARY OF THE INVENTION

The invention provides for a kit containing a sweetener composition having a non-standard level of sweetness, a container having a portion for holding the sweetener composition, and an indicator for communicating the sweetness intensity, as well as a method of sweetening comestible products with such kits as described in the claims.

### BRIEF DESCRIPTION OF THE FIGURES

For a better understanding of the present invention, reference is made to the following detailed description of an exemplary embodiment considered in conjunction with the accompanying drawings, in which:

FIG. 1 is a front view of a sample container holding a bulk sweetener composition, wherein the container has a graphical indication reflecting the sweetness level of the bulk sweetener composition. FIG. 1A-FIG. 1D illustrate alternative embodiments of the graphical indication.

FIG. 2 is a front view of a sample container holding a bulk sweetener composition, wherein the container has a numerical indication reflecting the sweetness level of the bulk sweetener composition. FIG. 2A-FIG. 2D illustrate alternative embodiments of the numerical indication.

FIG. 3 is a front view of a sample container holding a bulk sweetener composition, wherein the container has a written descriptive indication reflecting the sweetness level of the bulk sweetener composition. FIG. 3A-FIG. 3D illustrate alternative embodiments of the numerical indication.

FIG. 4A is a front view of a sample packet holding a unit-sized amount of sweetener composition, wherein the packet incorporates a numeric indication along with a graphic indication to reflect sweetness of the sweetener composition therein. FIG. 4B is the rear view of the packet.

FIG. 5A is a front view of a sample packet holding a unit-sized amount of sweetener composition, wherein the packet incorporates a written text indication along with a graphic indication to reflect sweetness of the sweetener composition therein. FIG. 5B is the rear view of the packet.

### DETAILED DESCRIPTION OF THE INVENTION

It is believed that one skilled in the art can, based upon the description herein, utilize the present invention to its fullest extent. The following specific embodiments are to be construed as merely illustrative, and not limitative of the remainder of the disclosure in any way whatsoever.

Unless defined otherwise, all technical and scientific terms used herein have the same meaning as commonly understood by one of ordinary skill in the art to which the invention belongs. Also, all publications, patent applications, patents, and other references mentioned herein are incorporated by reference. As used herein, all percentages are by weight unless otherwise specified.

As used herein, a “standard unit” shall be any customary unit of volumetric measure suitable for sucrose, such as a teaspoon, a tablespoon, a fluid ounce, a pound, a cup, a pint, a quart, a gallon, a milliliter, a deciliter, a liter, a gram, a kilogram, an ounce, or the like, or multiples thereof.

As used herein, a “standard unit dosage” or “standard unit dose” shall be any customary means for delivering a single serving of solid sucrose, and may refer to the dosage form itself such as a capsule, tablet, or pill; a cube, and the like, or the individual unit package forms such as a free-flowing solid in a sachet or a packet;

As used herein, “calorie(s)” shall refer to Kcal(s).

As used herein, a gram (or other given amount) of “Sucrose Equivalent Sweetness” (or “SES”) shall mean the amount of sweetener composition, e.g. a HIS-containing sweetener composition, needed to be added (“Added HIS Amount”) to an 8 ounce glass of water in order to provide the same sweetness as an independent 8 ounce glass of water containing 1 gram (or that other given amount (“Comparative Amount”) of sucrose. For example, 1/200 g of aspartame will equal about 1 gram of Sucrose Equivalent Sweetness because aspartame is about 200 times sweeter than sucrose. Similarly, about 1/500 g to about 1/600 g of sucralose will provide one gram of Sucrose Equivalent Sweetness because sucralose is about 500 to about 600 times sweeter than sucrose.

As used herein, the “Relative Dry Sweetness Density” for a given sweetener composition may be expressed as follows:

$$Relative Dry Sweetness Density = \frac{( Comparative Amount of sucrose )}{( Added HIS Amount of sweetener composition . )}$$

As used herein, a “non-standard level of sweetness” shall mean, for a given standard unit dosage of a sweetener composition, that the composition possesses a sweetness that is either greater than or less than the sweetness of any standard unit of sucrose by at least 2%, i.e., e.g., at least 3% or at least 4% or at least 5% or at least 6% or at least 7% or at least 8% or at least 9%.

The first embodiment of the present invention is directed to a kit for sweetening a comestible product, said kit comprised of, consisting of, and/or consisting essentially of a sweetener composition and a container having a portion for holding the sweetener composition, wherein the sweetener possesses a non-standard level of sweetness relative to a standard unit dose of sucrose, and the container possesses an indicator for communicating the sweetness intensity of the sweetener composition relative to the sweetness intensity of that standard unit dose of sucrose. Beneficially, the use of this kit enables a consumer to use a standard unit or standard unit dosage to sweeten a comestible product to a non-standard level of sweetness in a convenient, repeatable way.

Examples of suitable sweeteners include the nutritive sweeteners, high intensity sweeteners, and mixtures thereof. Suitable nutritive sweeteners include, but are not limited to sucrose, galactose, xylose, mannose, trehelose, tagatose, stereo isomers of natural sugars, dextrose, glucose, fructose, honey, corn syrup, molasses and mixtures thereof. Examples of suitable high intensity sweeteners include, but are not limited to sucralose, aspartame, saccharin, cyclamate, neotame, alitame, acesulfame potassium; sweet proteins such as brazien; extracts of sweet plants such as stevia; and their salts and derivatives thereof; and mixtures thereof.

In one embodiment, the high intensity sweetener that is employed in the invention is sucralose, which is the compound 4,1′, 6′-trichloro-4,1′, 6′-trideoxygalactosucrose.

Optionally, the sweetener composition may include additional enhancing agents. As used herein, “enhancing agents” are any agents that may affect the flavor, texture, nutritional value, color, sweetness, and/or the like of a comestible product. Examples of enhancing agents suitable for use in the present invention include, but are not limited to sweeteners; flavorants; nutritional components such as vitamins, mineral, and nutritional supplements; colorants or mixtures thereof.

The amount of other enhancing agents used in the sweetener composition may vary based upon the desired enhancement of the comestible product; however, one skilled in the art would readily appreciate without undue experimentation the amount of enhancing agents suitable for use in the sweetener composition.

Suitable flavorants include any synthetic or natural agent that would provide an acceptable flavor to the comestible product and is acceptable for use in food products. Example of suitable flavoring agents include, but are not limited to spices such as pepper, onion, garlic, and the like; salts such as sodium chloride; acids such as citric acid, ascorbic acid, and maleic acid; fruit extracts such as lemon oil, and the like.

Examples of suitable nutritional components include, but are not limited to vitamins, such as vitamin D, vitamin B6, ascorbic acid, sterols and stanols and their fatty acid esters, which are commercially available from McNEIL NUTRITIONALS, LLC. under the tradename, “BENECOL®,” probiotics products such as those containing bacteria from the genera Lactobacillus or Bifidobacterium, Escherichia, Enterococcus, Bacillus and/or yeast from the genera Saccharomyces, and mixtures thereof.

Examples of suitable colorants include any food-quality dyes.

The enhancing agent may be combined with other optional ingredients typically found in food products including but not limited to carriers such as fructo-oligosacharides; thickeners such as guar gum; bulking agents such as polydextrose; preservatives such as sodium benzoate; anti-moisture agents or anti-gelling agents, such as silica gel, and the like.

The sweetener composition suitable for use in this embodiment possesses a non-standard level of sweetness. For example, a standard unit of the sweetener composition may possess a degree of sweetness when dissolved in 8 ounces of water that is greater than about 1.04 times, i.e., greater than about 1.075 times or greater than about 1.10 times or greater than about 1.2 times the degree of sweetness provided by the same standard unit of sucrose when dissolved in an independent 8 ounces of water. Alternatively, a standard unit of the sweetener composition may possess a degree of sweetness when dissolved in 8 ounces of water that is less than about 0.96 times, i.e., less than about 0.925 times or less than about 0.90 times or less than about 0.80 times the degree of sweetness provided by the same standard unit of sucrose when dissolved in an independent 8 ounces of water.

The sweetness level per unit volume of the sweetener composition may be modified by adjustment of the fill volume of a unit size package, by selection of the type and concentration of sweetener, as well as by the selection of the type and amount of other optional ingredients such as carriers, binders, thickeners, bulking agents, preservatives, anti-moisture agents, anti-gelling agents and the like. In one embodiment, diluents such as carbohydrates or other food grade materials of lower sweetness intensity, water, air, alcohols, and the like may be combined with the selected sweetener in order to arrive at the desired sweetness level. The sizes of tablets and cubes can also be changed.

In one embodiment the carrier component of the edible composition may be comprised of any material suitable for incorporation into food regardless of its specific caloric density as long as the amount used provides less than about 0.49 calories, e.g., less than about 0.4 calories or less than about 0.1 calories or less than about 0.05 calories or less than about 0.01 calories, per gram of Sucrose Equivalent Sweetness. In one embodiment, the carrier is a free-flowing, water soluble material, and in another embodiment the carrier may be capable of providing a low glycemic response. In another embodiment, the carrier may be a non-water soluble material. In yet another embodiment, the carrier can be a mixture of water soluble and non soluble materials. As used herein, “low glycemic response” shall mean a compound that, when ingested, provides a peak insulin response which is less than the peak insulin response produced by ingesting an an equivalent amount of sucrose. The carrier may also facilitate the emptying of the HIS/carrier composition from the container or provide other benefits as disclosed in U.S. Pat. No. 6,809,198.

Examples of suitable water soluble carriers include, but are not limited to sucrose, dextrose, fructose, galactose, lactose, maltose, maltodextrose and other glucans, inulin and other fructans, polydextrose, xylans, galactans, nutritive sugar, sugar alcohols and other polyols, or combinations thereof.

Examples of suitable non-soluble carriers include celluloses such as those available from International Fiber Corporation under the tradename, “Solka Floc®;” water insoluble fractions of starches, resistant starches, and modified versions thereof; diatomaceous earth; lignins of various plants such as, for example, corn or trees such as larch; complex aromatic polymers and co-polymers formed from coumaryl, guaiacyl, coniferyl, or sinapyl alcohols; water insoluble hemicelluloses; water insoluble portions of amylose or amylose pectin; water insoluble fiber from plants such as, for example, nuts, oats, wheat, rice, barley, corn,or bamboo; fibers from fruits such as apples; and water insoluble fiber from vegetables such as peas, or combinations thereof.

The sweetener composition can be produced by combining the desired components via dry mixing, co-spray drying, co-freeze drying, agglomerization, blending, co-drying, extrusion, panning, serial blending, compaction, or by any other convenient process. The primary consideration is that the sweetness delivery needs to be uniform.

The container may be in a format to hold bulk sweetener composition or may be in a format to hold the sweetener composition in standard unit dose packages. In one embodiment, the sweetener composition may be packaged in a container that does not require any tools or secondary devices to open. For example, the container may be opened by tearing the paper or by removing a cap or lid as appropriate. The container may be flexible or rigid. Examples of suitable container formats include but are not limited to packets, sachets, pouches, tubs, cups, jars, bags, and the like.

One skilled in the art would readily appreciate without undue experimentation the types of materials suitable for making the container, which may include, but are not limited to moisture limiting packaging such as metallized or aluminum foil laminated substrates such as a polymer films or a kraft paper. Suitable polymers include but are not limited to polyolefins (such as high-density (linear) polyethylene, polypropylene, etc.), polyesters (such as polyalkyl terephthalates e.g. polyethylene terephthalate, polycyclohexane-1,4- dimethylene terephthalate, polybutylene terephthalate, etc.), polyvinyl chloride, polyvinyl fluoride, and copolymers of polyvinyl chloride and polyvinyl fluoride.

Additional formats for the container include, but are not limited to, multi-walled paper bags having a suitable moisture barrier, fiber drums having polymeric or aluminum foil linings integral with the drum wall or loose liners inserts. Rigid containers such as blow molded drums and pails made of polymers with moisture barriers may also be used. The container may be a flexible package such as a shipping bag made of a polymer substrate. In one embodiment, the bag may be made from aluminum foil laminated to polymer films formed from polymers that are commonly used to make moisture resistant packaging (e.g. laminates of aluminum foil with polyolefins, polyesters, styrenics or copolymers thereof).

The sweetener composition can be sold to customers in bulk, in individual, standard unit dose containers, or within a multi-container unit. In one embodiment, several standard unit packages may be contained within a master package, e.g., a multi-unit package, in order to facilitate the sale of multiple quantities of the packages. In another embodiment, the sweetness levels of the sweetener composition within the standard unit dose packages may be varied so as to provide convenient sweetness choices to the consumer. In another embodiment, the container may have hanging means, including but not limited to holes, hooks, flaps, and the like, that are designed to permit the container to hang from pegs or clips on a store wall or be otherwise attached to a shelf or wall in a store.

In another embodiment, the container for the sweetener composition may be overwrapped with a secondary packaging materials, such as various plastic and polymer films well known to those skill in the art, cardboard box, and the like.

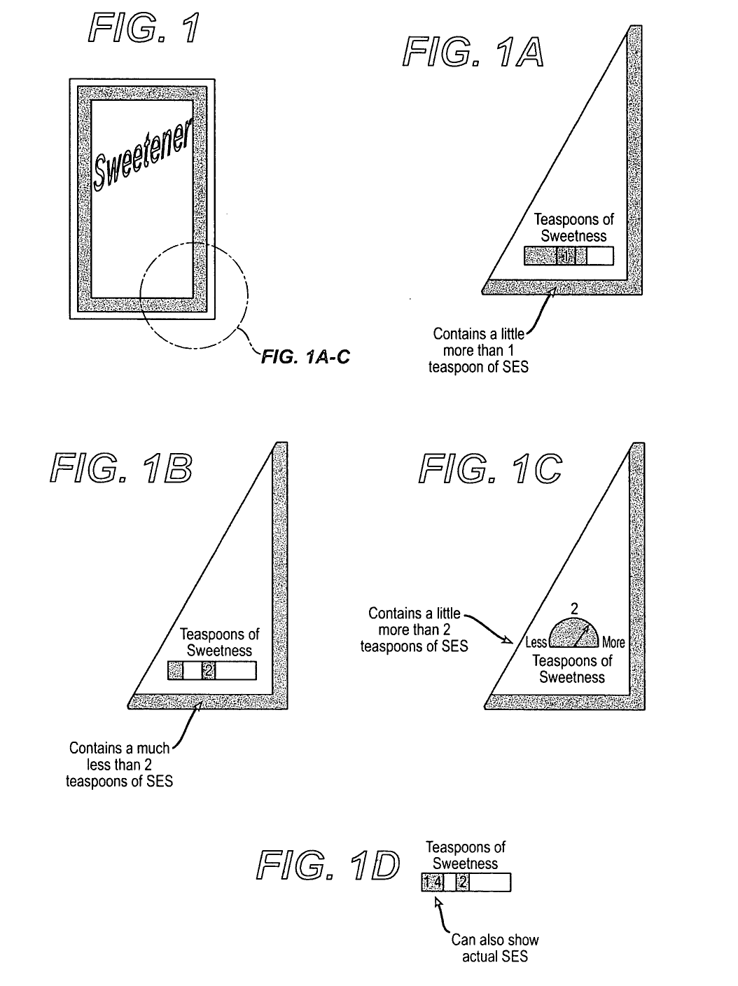

The design of the indicator for communicating the relative difference in sweetener intensity levels between a standard unit of the sweetener composition and a standard unit of sucrose is not critical. However, the indicator must clearly and consistently describe the deviation in sweetness intensity of the sweetener composition relative to the sweetness possessed by the standard unit of sucrose. For example, the communication means may incorporate graphic forms, numeric forms, and/or descriptive forms. FIG. 1 illustrates various embodiments of a graphical sweetener level indication on a bulk sweetener product. FIG. 1A uses a bar graph to show that a teaspoon of the sweetener composition possesses a sweetness level that is greater than the sweetness of 1 teaspoon of sucrose. FIG. 1B uses a bar graph to show that a teaspoon of the sweetener composition possesses a sweetness level that is less than the sweetness of 1 teaspoon of sucrose. FIG. 1C uses a dial to show that a teaspoon of the sweetener composition possesses a sweetness level that is greater than the sweetness of 2 teaspoons of sucrose. FIG. 1D uses a bar graph with numeric indications to show that a teaspoon of the sweetener composition possesses a sweetness level that is less than the sweetness of 2 teaspoons of sucrose and more specifically that is possesses a SES of 1.4.

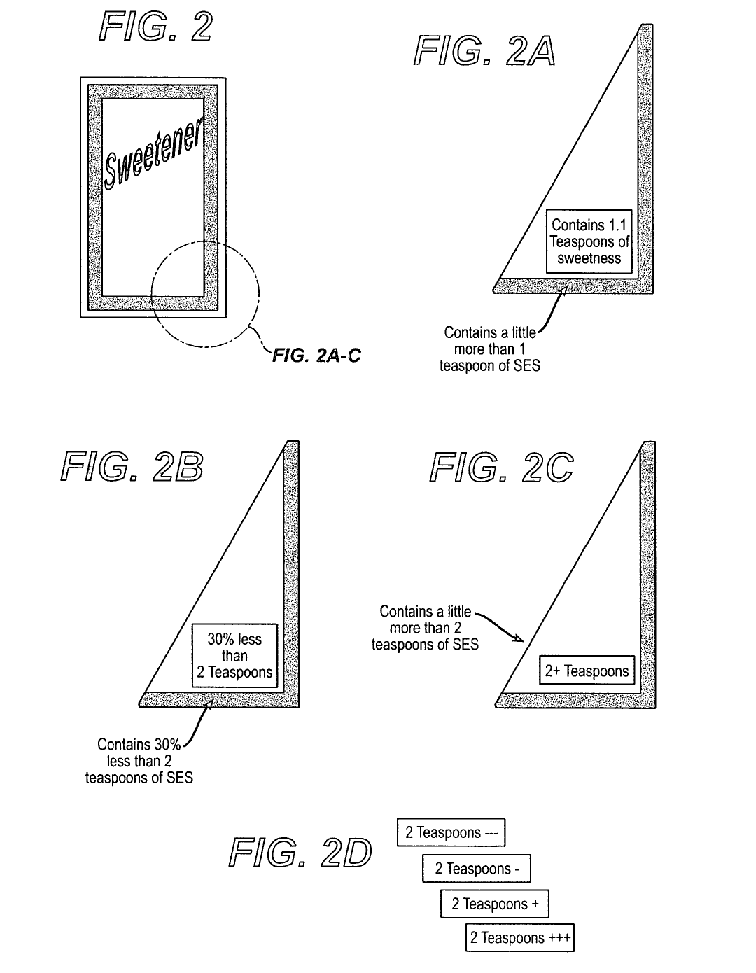

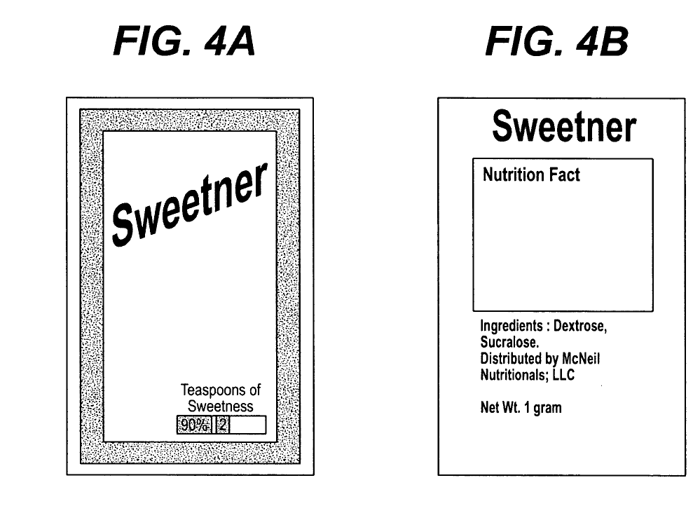

FIG. 2 illustrates various embodiments of a numeric sweetener level indication on a bulk sweetener product. FIG. 2A uses a numeric indication to show that a teaspoon of the sweetener composition possesses a sweetness level that is greater than the sweetness of 1 teaspoon of sucrose, and more specifically that it possesses a SES of 1.1. FIG. 2B uses a numeric indication to show that a teaspoon of the sweetener composition possesses a sweetness level that is greater than the sweetness of 2 teaspoons of sucrose, and more specifically that it possesses a sweetness that is ³⁰% greater than that of 2 teaspoons of sucrose. FIG. 2C uses a numeric indication along with a graphic indication to show that a teaspoon of the sweetener composition possesses a sweetness level that is greater than the sweetness of 2 teaspoon of sucrose. By varying the number of graphic indicators as illustrated in FIG. 2D, e.g., a “+” or “−”, the consumer can determine if a teaspoon of the sweetener composition is a lot sweeter than 2 teaspoons of sucrose, e.g,. “2 Teaspoons +++,” or is somewhat less sweeter than 2 teaspoons of sucrose, e.g., “2 Teaspoons −.” FIG. 4 illustrates a packet that also uses a numeric indication along with a graphic indication to show that a teaspoon of the sweetener composition possesses a sweetness level that is less than the sweetness of 2 teaspoons of sucrose, and more specifically that is has a sweetness level that is 80% of the sweetness possessed by 2 teaspoons of sucrose.

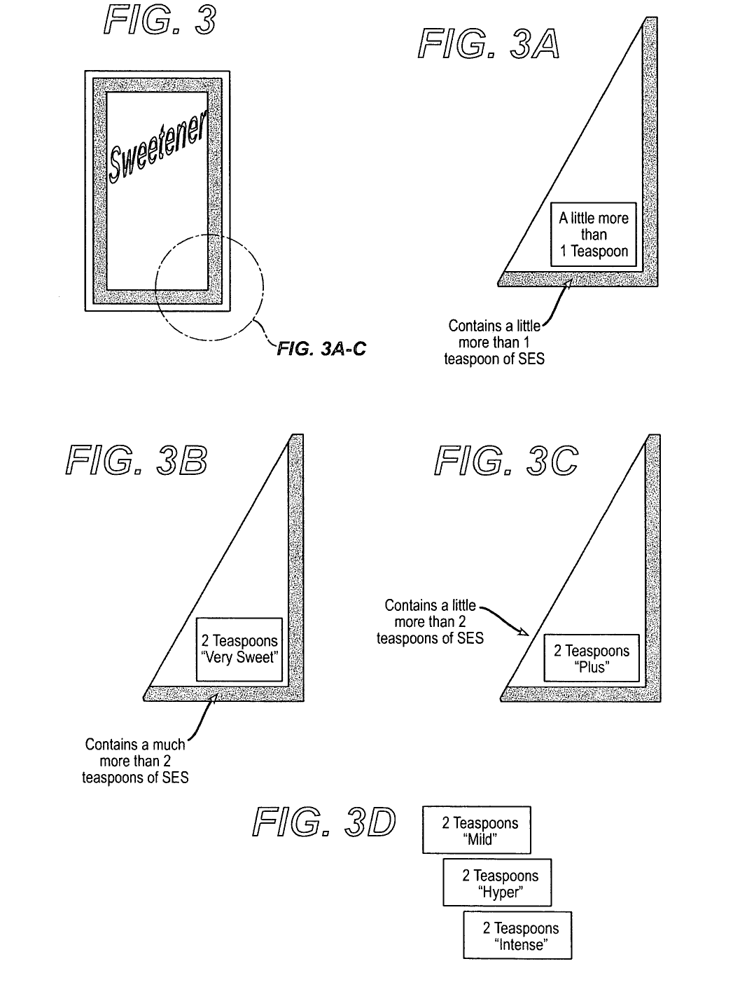

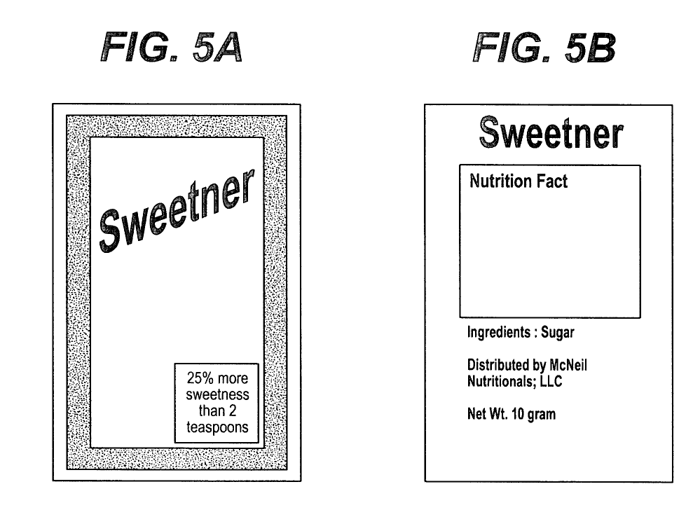

FIG. 3 illustrates various embodiments of a descriptive sweetener level indication on a bulk sweetener product. FIG. 3A uses text to convey that a teaspoon of the sweetener composition possesses a sweetness level that is “a little more than 1 teaspoon.” By contrast, FIGS. 3B and 3C use descriptive text to indicate that a teaspoon of the sweetener composition is much sweeter than 2 teaspoons of sucrose. FIG. 3D illustrates alternative words to describe the relative sweetness of the sweetener composition, i.e., e.g., a sweetness less than that 2 teaspoons of sucrose (“mild”) to that much greater than that of 2 teaspoons of sucrose (“intense”). FIG. 5 illustrates a packet that also uses text to convey that a teaspoon of the sweetener composition possesses a sweetness level that is 25% more than the sweetness of 2 teaspoons of sucrose.

For purposes of illustration, the sweetness of a teaspoon of sweetener composition was compared to the standard unit of sucrose illustrated on the container. However, the amount of sweetener composition used for comparison may vary, and could even be a non-standard volumetric amount measurable by a custom sized measuring device provided with the container of sweetener composition.

Advantageously, the kit for sweetening a comestible product which contains a sweetener composition having a non-standard level of sweetness enables a consumer to conveniently select the level of sweetness for a particular application and precisely repeat the use of that sweetness level. As a result, the use of this kit results in less sweetener waste, which minimizes cost and waste disposal. In embodiments wherein the kit employs a standard unit dosage, the consumer conveniently may sweeten a comestible product, such as a bulk beverage, by only opening a single packet.

In one embodiment, the amount of sweetener composition in the edible composition may be customized for use in a specific food product application, such as that amount of sweetener required for use in a particular cake mix, cookie mix, bread mix, brownie mix, drink mix, or cereal. This embodiment would facilitate the production and manufacture of unsweetened base food products, and would provide the consumer with the option of sweetening that food product with either a nutritive or high intensity sweetener.

In another embodiment of the present invention, the edible composition may be comprised of an enhancing agent that is a low calorie, palatable sugar substitute composition comprising, consisting of, and/or consisting essentially of a) a high intensity sweetener in an amount sufficient to provide greater than about 10 grams of Sucrose Equivalent Sweetness; and b) a carrier, wherein said carrier provides less than about 0.49 calories, e.g., less than about 0.4 calories or less than about 0.1 calories or less than about 0.05 calories or less than about 0.01 calories, per gram of Sucrose Equivalent Sweetness.

Examples of suitable high intensity sweeteners include any of those set forth above.

The amount of HIS suitable for use in the edible composition of the present invention may be expressed in terms of “Sucrose Equivalent Sweetness.” For example, the edible composition may be comprised of an amount of HIS that would provide the sweetness equivalent of 1 cup (or about 200 grams) of sucrose, or 1 liter (about 600 grams) of sucrose. Alternatively, the HIS in the edible composition may provide the Sucrose Equivalent Sweetness to any other amount of sucrose, such as for example unit amounts of quarts, pints, 100 grams, kilograms, pounds, and the like.

In embodiments wherein the edible composition may be removably attached to the preparation of unsweetened prepared comestible products, sucralose (or other high intensity sweetener) is often used in the recipe in the amount to provide the equivalent amount of sweetness of the sugar it replaces. For example, because sucralose is about 600 times as sweet as sugar, it may be used in approximately 1/600 the amount of sugar replaced. That is, the HIS is used in an amount to provide the Sucrose Equivalent Sweetness of at least a gram, i.e., e.g., at least 50 grams, 100 grams or 150 grams of sucrose.

In one embodiment, an amount of the edible composition may be removably attached to a comestible product (or container therefor) such that the caloric content of the comestible product is significantly less than the corresponding comestible made with sugar, i.e., e.g., from about 5% fewer calories up to a one-third or more reduction in calories, and also significantly less than the HIS that is in commercially available delivery forms, e.g., packets or granular form.

Advantageously, this embodiment of the present invention permits the user to select the level of enhancing agent, such as a sweetener, for a particular application. In addition, this invention permits the use to have the enhancing agent readily available for consumption at the point of use. Further, the present invention provides the ability for a common host product to have a multitude of flavor and/or sweetness options, which thereby simplifies the manufacturing and distribution logistics of a flexible product line. Further, when a sweetener having a non-standard level of sweetness is used, a consumer is capable of customizing the sweetness level of a comestible product in more precise, convenient, and repeatable manner.

The invention illustratively disclosed herein suitably may be practiced in the absence of any component, ingredient, or step which is not specifically disclosed herein. Several examples are set forth below to further illustrate the nature of the invention and the manner of carrying it out. However, the invention should not be considered as being limited to the details thereof.

### EXAMPLES

### Example 1

### Packet with Sweetening Composition Having Non-Standard Sweetness

A small polyethylene coat paper packet is filled with a dry blended mixture of 1 gram of dextrose and 13.1 mg of sucralose, which is commercially available from Tate & Lyle under the tradename, “SPLENDA”®. The sweetness provided is equivalent to ⁹⁰% of that provided by 2 teaspoons of sucrose. The packet contains a graphical indication of the relative sweetness level of the sweetener composition as illustrated in FIG. 4.

### Example 2

### Packet with Sweetening Composition Having Non-Standard Sweetness

A small polyethylene coated paper packet is filled with 10 grams of sucrose. The sweetness provided by the sucrose contained therein is equivalent to 125% of that provided by 2 teaspoons of sugar. The packet contains a numerical indication of the relative sweetness level as illustrated in FIG. 5.

### Example 3

### Bag with Sweetening Composition Having Non-Standard Sweetness

A small sealed paper bag is filled with a dry blended mixture of 0.5 grams of sucralose and 5 grams of short chain fructo-oligosaccharide, which is commercially available from GTC Nutrition LLC under the tradename, (“Nutraflora”). The sweetness provided was equivalent to 80% of that provided by 1 cup of sugar. The packet contains a descriptive indication of the relative sweetness level as illustrated in FIG. 6.

### Example 4

### Master Package Containing Unit Packets with Sweetening Composition Having Non-Standard Sweetness

A set of 20 small polyethylene coated paper packets are each filled with a dry-blended mixture of 1 gram of dextrose and 12 mg of sucralose, then are placed in a cardboard box.

Additional sets of 20 similar packets are similarly prepared, but with the substitution of sucralose in amount of 11 mg, 10 mg, 9 mg, and 8 mg, respectively.

Each packet contains a numerical indication of the relative sweetness level of the sweetener composition contained therein. The outer box also has a numerical indication of the range of sweetness levels possessed by the different sweetener compositions within the packets found in the box.

### Example 5

### Bulk Sweetening Composition Having Non-Standard Sweetness

A solution is made by mixing 0.0095 lbs of sucralose, 0.6154 lbs of maltodextrin, and 5.625 lbs of water under ambient conditions. The solution is then spray dried for about 5 to about 10 minutes at about 250° F. to about 420° F. degrees in a tower spray dryer to produce a low bulk density at about 0.05 g/cc to about 0.7 g/cc and a moisture level of about 1 percent to about 5 percent.

1.905 teaspoons of the resultant free flowing granular material provide the equivalent sweetness of 2 teaspoons of sucrose when dissolved in 8 ounces of water. In other words, 1.905 teaspoons of the granular material equals about 2 teaspoons of SES, or has a Dry Relative Sweetness Density of 1.05.

The resulting material is filled into a metallized paperboard box with a numerical indication of the relative sweetness level.

### Example 6

### Packet with Sweetening Composition Having Non-Standard Sweetness

A small polyethylene coat paper packet is filled with a dry blended mixture of 3.6 gram of sucrose and 6.55 mg of sucralose, which is commercially available from Tate & Lyle under the tradename, “SPLENDA®.” The sweetness provided is equivalent to 90% of that provided by 2 teaspoons of sucrose. The packet contains a graphical indication of the relative sweetness level of the sweetener composition as illustrated in FIG. 4. The energy density of the composition is about 1.8 kcals per gram of SES.

### Example 7

### Packet with Sweetening Composition Having Non-Standard Sweetness

A small polyethylene coat paper packet is filled with a dry blended mixture of 7 grams of sucrose and 0.364 mg of sucralose, which is commercially available from Tate & Lyle under the tradename, “SPLENDA®.” The sweetness provided is equivalent to 90% of that provided by 2 teaspoons of sucrose. The packet contains a graphical indication of the relative sweetness level of the sweetener composition as illustrated in FIG. 4. The energy density of the composition is 3.5 kcals per gram of SES.

What is claimed is:

1. A kit for sweetening a comestible product, said kit comprised of:
a) a sweetener composition having a non-standard level of sweetness; and
b) a container having a portion for holding the sweetener composition, said container having an indicator for communicating the sweetness intensity of the sweetener composition relative to the sweetness intensity of a standard unit dosage of sucrose.

2. The kit of claim 1, wherein in the non-standard level of sweetness is greater than about 1.04 times or less than about 0.96 times the sweetness intensity of the standard unit dosage of sucrose.

3. The kit of claim 1, wherein in the non-standard level of sweetness is greater than about 1.075 times or less than about 0.925 times the sweetness intensity of the standard unit dosage of sucrose.

4. The kit of claim 1, wherein in the non-standard level of sweetness is greater than about 1.10 times or less than about 0.90 times the sweetness intensity of the standard unit dosage of sucrose.

5. The kit of claim 1, wherein in the sweetener composition has an energy density that is less than about 4 kcals per gram of sucrose equivalent sweetness.

6. The kit of claim 1, wherein in the sweetener composition has an energy density that is less than about 2 kcals per gram of sucrose equivalent sweetness.

7. The kit of claim 1, wherein the sweetener composition is comprised of a sweetener selected from the group consisting of sucrose, galactose, xylose, mannose, trehelose, tagatose, stereo isomers of natural sugars, dextrose, glucose, fructose, honey, corn syrup, molasses, sucralose, aspartame, saccharin, cyclamate, neotame, alitame, acesulfame potassium, brazien, stevia extract, and their salts and derivatives thereof, and mixtures thereof.

8. The kit of claim 1, wherein the sweetener composition is comprised of a sweetener selected from the group consisting of sucralose, aspartame, saccharin, cyclamate, neotame, alitame, acesulfame potassium, brazien, stevia extract, and their salts and derivatives thereof, and mixtures thereof.

9. The kit of claim 1, wherein the sweetener composition is comprised of sucralose or a blend of sucralose with another high intensity sweetener.

10. The kit of claim 9, wherein the sweetener composition is further comprised of a nutritive sweetener.

11. The kit of claim 1, wherein the sweetener composition is in a standard unit dosage form.

12. The kit-of claim 1, wherein the container is in the form of a bag, box, sachet, packet, pouches, tub, cup, or jar.

13. The kit of claim 1, wherein the sweetener composition is in a solid form.

14. The kit of claim 1, wherein the sweetener composition is in a liquid form.

15. The kit of claim 1, wherein the indicator is in a graphical, numerical or descriptive format.

16. A multi-container carton comprised of a plurality of the kits of claim 1.

17. The multi-container carton of claim 16, wherein said plurality is comprised of at least a first kit having a first sweetener composition and a second kit having a second sweetener composition, wherein the sweetness intensity of the first sweetener composition is different that the sweetness intensity of the second sweetener composition.

18. A method of sweetening a comestible product comprised of adding a sweetener composition from the kit of claim 1 to the comestible product.

19. A kit for sweetening a comestible product, said kit comprised of:
a) a sweetener composition comprised of a high intensity sweetener having a dry relative sweetness density that is greater than about 1.04 or less than about 0.96; and
b) a container having a portion for holding the sweetener composition, said container having an indicator for communicating the sweetness intensity of the sweetener composition relative to the sweetness intensity of a standard unit dosage of sucrose.

20. The kit of claim 19, wherein in the dry relative sweetness density is greater than about 1.1 or less than about 0.90.

21. The kit of claim 19, wherein in the dry relative sweetness density is greater than about 1.2 or less than about 0.80.

22. The kit of claim 19, wherein the sweetener composition is comprised of a sweetener selected from the group consisting of sucralose, aspartame, saccharin, cyclamate, neotame, alitame, acesulfame potassium, brazien, stevia extract, and their salts and derivatives thereof; and mixtures thereof.

23. The kit of claim 19, wherein the sweetener is sucralose or a blend of sucralose with another high intensity sweetener.

24. The kit of claim 19, wherein the container is in the form of a bag, box, sachet, packet, pouches, tub, cup, or jar.

25. The kit of claim 19, wherein the sweetener composition is in a solid form.

26. The kit of claim 19, wherein the sweetener composition is in a liquid form.

27. The kit of claim 19, wherein the indicator is in a graphical, numerical or descriptive format.
